(19) United States
(12) Patent Application Publication
(10) Pub. No.: US 2006/0148363 A1
(43) Pub. Date: Jul. 6, 2006

(54) OSB from wood strands and alternate fibers

(76) Inventor: Gerard Lavoie, Marieville (CA)

Correspondence Address: E. F. & Co, 316 Knowlton Road, Lac Brome, QC, JOE 1V0, CA

(21) Appl. No.: 11/290,068

(22) Filed: Nov. 30, 2005

(30) Foreign Application Priority Data
Jan. 6, 2005 (CA) S. N. 2,491,638

(51) Int. Cl. D04H 3/05; D04H 1/74; B32B 21/10; D04H 1/00

(52) U.S. Cl. 442/413; 442/417; 442/366; 442/369

(57) ABSTRACT

An improved oriented strand board which comprises at least one inner or core layer and two exterior or face layers, each of the layers comprising strands of a wood product mixed with an appropriate binder, at least a portion of the wood product being replaced with stems of a plant, the stems preferably being oriented in the same direction as the strands of the wood product. Preferably, the plant stems are flax stems or soybean stems or a mixture of flax and soybean stems.

### FIELD OF THE INVENTION

The present invention relates to oriented strand board and more particularly, relates to improvements in engineered oriented strand board.

### BACKGROUND OF THE INVENTION

The manufacture of composite boards formed of a variety of lignocellulosic materials is well known in the art. Originally, waferboard consisting of randomly placed wafers of a wood product held together by an adhesive was developed to meet the needs for boards similar to plywood.During the evolution of such boards, oriented strand board was developed wherein the strands are oriented in a predetermined direction. The technology has advanced to the point that oriented strand board has now virtually replaced most other structural boards in residential construction. Virtually all building codes in North America recognize oriented strand boards as being suitable for the same use as plywood on an equal thickness basis.

Oriented strand board is an engineered, mat-formed board manufactured from strands, flakes or wafers sliced from small diameter round wood logs and bonded with suitable binder under heat and pressure.

Oriented strand board consists of several layers of strands also known as a mat of strands. The exterior or face layers are formed of strands aligned in the longer board direction and represent approximately 55% of the total board weight. Inner or core layers consist of cross or randomly aligned strands and represent the balance of about 45% of the weight of the board. Once the mat have been formed e.g. all the layers have been put together, it is subjected to intense heat and pressure to become a master board and is subsequently cut to size. The strand dimensions are mill dependent. Generally speaking, the strand geometry is rectangular: up to 6 inches (150 mm) for the length, up to 4 inches (100 mm) for the width and up to 0.030 inch (0.762 mm) for the thickness.

The strength of oriented strand boards comes mainly from the uninterrupted wood fiber, the interweaving of the long strands and the degree of orientation of the strands. Suitable resins are combined with the strands to provide the desired mechanical board properties and moisture resistance. As a performance based structural use board, oriented strand boards are recognized by all major building code agencies in North America, Europe and Japan.

Manufacturing process of an oriented strand board consists in many steps. The trees, after harvesting, are hauled to the mill's wood yard then sorted according to the species. Known in the art, wood is the only component in OSB. Many wood species can be used to manufacture OSB e.g. Aspen for the Northern mills and Southern Yellow Pine for the Southern mills. Mixing two or more wood species can be done too depending on wood species availability close to the mill. If necessary, logs are cleaned and/or soaked to remove extraneous material (e.g. sand, ice etc.). Consequently, logs are run through the debarker to remove bark which is used as fuel in the mill's energy supply. From the debarker, the logs are sent to the strander : whole logs are cut into rectangular strands. The strand dimensions are mill dependent. Generally speaking, the strand geometry is rectangular: up to 6 inches (150 mm) for the length, up to 4 inches (100 mm) for the width and up to 0.030 inch (0.762 mm) for the thickness. Prior to binder application, strands are dryed until the appropriate moisture content is reached. The appropriate strand moisture content depends on binder types and strand layers (e.g. core layers or face layers). The strands are then sent to the blender where they are blended with resin binders (such as phenol-formaldehyde (PF) resin or poly-isocyanate resin often called PMDI) and a small amount of wax which improves the efficiency of the resin binder and enhances the board's resistance to moisture and water absorption. Cross-directional core and face layers (mat of strands) are formed at the forming line. The layers of strands or mat of strands is then pressed under intense heat and pressure to form a rigid, dense structural board of oriented strands or OSB. At the finishing line, boards are cooled, cut to size, grade stamped, stacked in bundles and edge coated. All graded boards bear a mandatory certification agency stamp, plus the SBA logo if applicable.

### SUMMARY OF THE INVENTION

It is an object of the present invention to provide a modified oriented strand board wherein physical properties are engineered in a relatively inexpensive manner.

According to one aspect of the present invention, there is provided an improvement in an oriented strand board comprising one or two inner(s) or core layer(s) and two exterior or face layers, each of the layers comprising strands of wood product with a binder, the improvement wherein at least a portion of the wood product, either in the face layers or in the core layers or both in the face and in the core layers, is replaced with stems of one plant or of a mixture of plant stems (flax and soybean for example), the stems being or not oriented in the same direction as the strands of the wood product.

According to a further aspect of the present invention, there is provided a method of manufacture of an oriented strand board, the method comprising the steps of blending strands of wood product and plant stems with a resin binder, laying the strands and the plant stems in cross directional layers and pressing the strands and the plant stems under heat and pressure to form an oriented strand board.

According to a further aspect of the present invention, there is provided an oriented strand board comprising one or two inner or core layer(s) and two exterior or face layers of cross directionally oriented strands of a lignocellulosic material and a resin binder, the lignocellulosic material comprising a mixture of strands of a wood material and plant stems.

The wood strands used in the present invention may be any of the conventional wood strands presently used in such products. The aspect ratio of the wood strands may be varied as it is known in the art.

The plant stems may be selected from a number of different plants including, for example, wheat stem, barley stem, oat stem, soybean stalk, flax stem, hemp etc. As will be appreciated, the stems of plants such as flax have a low density compared to wood density and accordingly, one can provide a board with a lower density while maintening physical properties.

The plant stems preferably have a length of between 1 mm and 250 mm. Naturally, it will be understood that the product can be engineered using any plant stem lengths.

The cutting of the plant stems to the desired length can be accomplished on commercially available equipment.

The percentage of plant stems utilized may vary and generally would be between 1% and 50% by weight of the strands of the wood product. In a preferred imbodiment, the percentage by weight of the plant stems will vary between 1% and 25%.

According to the present invention, the plant stems used are substantially untreated. By this term, it is meant that the plant stems are not subjected to any substantial pre-treatment other than drying to a desired moisture level or then cut to the desired length. This means that the plant stems can be incorporated in the product with very little change to the present mill equipment and practices. However, it is understood that any treatment (mechanical chemical, etc.) can be apply to the plant stems if necessary.

### DETAILED DESCRIPTION OF THE INVENTION

Having thus generally described the invention, reference will be made to the drawings and examples which illustrate an embodiment of the invention, and wherein:

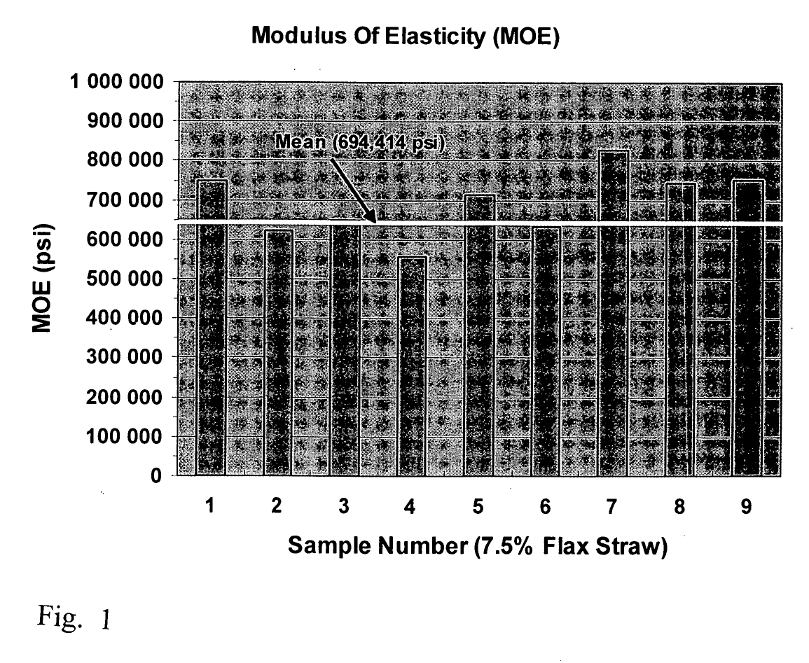

FIG. 1 is a graph showing the modulus of elasticity (MOE) for boards manufactured according to the present invention:

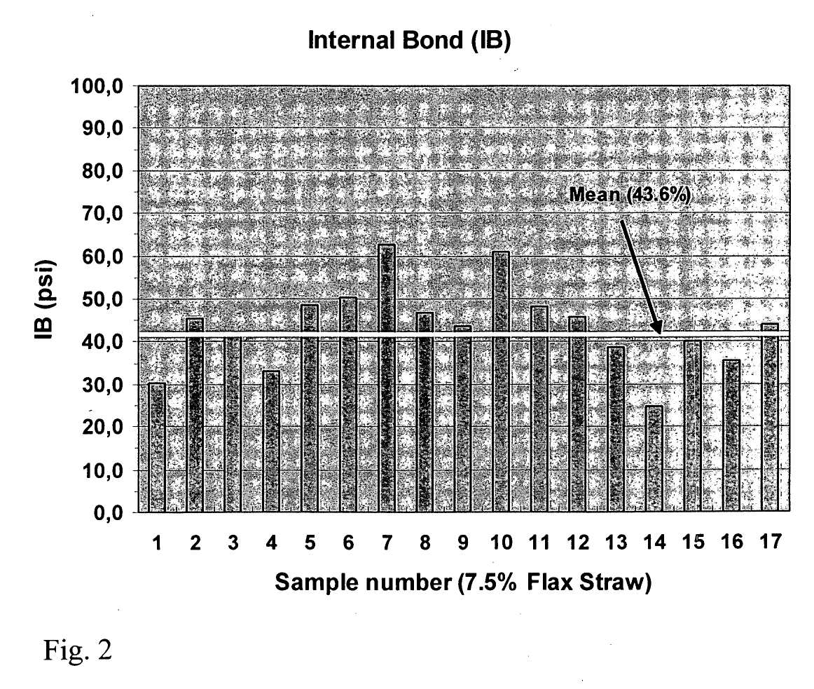

FIG. 2 is a graph illustrating the internal bond (IB) of the boards : and

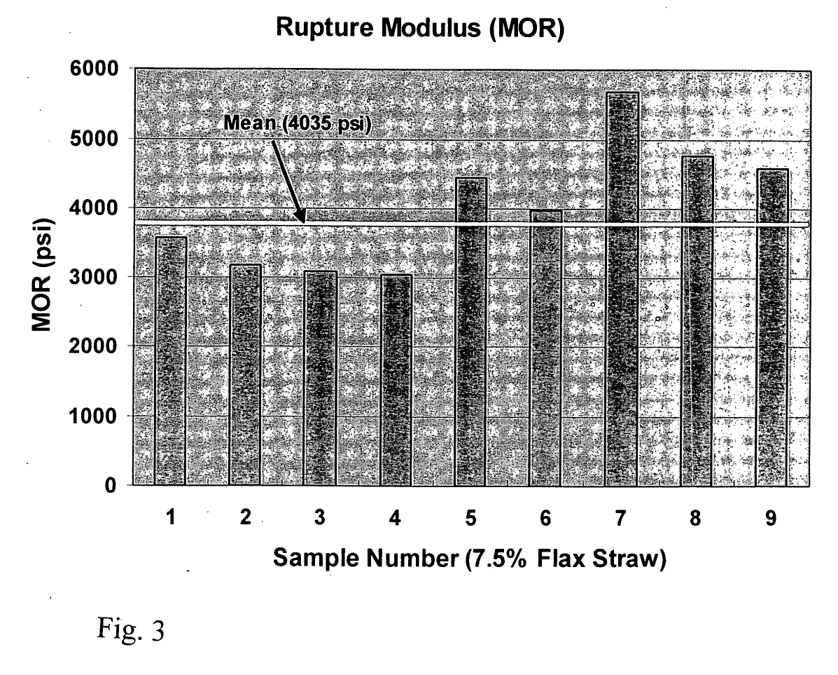

FIG. 3 is a graph illustrating the modulus of rupture (MOR) thereof.

Oriented strand boards (OSB) were manufactured of Aspen strands having a face/core weight ratio of 55%-45%. For the face layers, the liquid resin content was between 1%-2%, the powder resin of 1.5%-2.5% and a wax component of between 1.25%-2.0%.

For the core layers, the liquid resin content was between 1.5%-3.0%, the powder resin between 1.5%-3.0%, and the wax component between 1.25%-2.0%.

The water content of the face layers was 3.5% (dry basis) while the face layers had a water content of 6.0% (dry basis). Overall, the board density was 41.5 pounds per cubic foot.

| | |
|---|---|
| Wood | Aspen |
| Face/Core Ratio | 55%-45% |
| Resin | |
| Face layers | |
| Liquid resin | Between 1%-2% |
| Powder resin | Between 1.5%-2.5% |
| Wax | Between 1.25%-2.0% |
| Core layers | |
| Liquid resin | Between 1.5%-3.0% |
| Powder resin | Between 1.5%-3.0% |
| Wax | Between 1.25%-2.0% |
| Humidity | |
| Core layers | 3.50% |
| Face layers | 6.00% |
| Board Density | 41.5 lb/ft³ |

Overall, 7.5% of the wood strands was replaced by flax stems. A number of samples were manufactured and tested with the results given in FIGS. 1 to 3 for the modulus of elasticity (MOE), the internal bond (IB) and the modulus of rupture (MOR). As will be noted, all samples provided a product having good physical properties.

It will be understood that the above described embodiments are for purposes of illustration only and that changes and modifications may be made thereto without departing from spirit and scope of the invention.

I claim:

1. In an oriented strand board comprising at least one core layer and first and second face layers, each of said layers comprising strands of a wood product with a binder, the improvement wherein at least a portion of said wood product is replaced with stems of a plant.

2. The improvement of claim 1 wherein said stems of said plant have a length of between 1 mm and 250 mm.

3. The improvement of claim 2 wherein said stems of said plants comprise up to 50% by weight of said wood product.

4. The improvement of claim 2 wherein said stems are selected from flax, soybean, and hemp stems.

5. The improvement of claim 4 wherein said plant stems are present in said core layer of said oriented strand board.

6. The improvement of claim 4 wherein said plant stems are present in said face layers of said oriented strand board.

7. The improvement of claim 4 wherein said plant stems are present in all layers of said oriented strand board.

8. A method of manufacture of an oriented strand board, the method comprising the steps of:
blending strands of a wood product and plant stems with a resin binder;
laying said strands and said plant stems in cross directional layers; and
pressing said strands and said plant stems under heat and pressure to form said oriented strand board.

9. The method of claim 8 wherein said stems of said plants have a length of between 1 mm and 250 mm.

10. The method of claim 9 wherein said stems of said plant comprise between 1% and 50% by weight of said wood product.

11. The method of claim 10 wherein said stems are selected from flax stems, soybean, and hemp stems.

12. The method of claim 11 wherein said plant stems are present in at least one core layer of said oriented strand board.

13. The method of claim 12 wherein said plant stems are present in said face layers of said oriented strand board.

14. The method of claim 13 wherein said plant stems are present in all layers of said oriented strand board.

15. An oriented strand board comprising at least one core layer and first and second face layers of cross directionally oriented strands of lignocellulosic material and a resin binder, said lignocellulosic material comprising a mixture of strands of a wood material and plant stems.

16. The board of claim 15 wherein said stems of said plants have a length of between 1 mm and 250 mm.

17. The board of claim 16 wherein said stems of said plants comprise up to 50% by weight of said strands of said wood product.

18. The board of claim 17 wherein said stems are selected from flax, soybean, and hemp stems.

19. The board of claim 18 wherein said plant stems are present in said core layer of said oriented strand board.

20. The board of claim 19 wherein said plant stems are present in face layers of said oriented strand board.

21. The board of claim 20 wherein said plant stems are present in all layers of said oriented strand board.
